(19) United States
(12) Patent Application Publication
(10) Pub. No.: US 2011/0154593 A1
(43) Pub. Date: Jun. 30, 2011

(54) Car headlight cleaning device

(76) Inventor: Lyne Bourbeau, St-Denis-De-Brompton (CA)

(21) Appl. No.: 12/965,892

(22) Filed: Dec. 12, 2010

(30) Foreign Application Priority Data
Dec. 26, 2009 (GB) 0922567.3

(51) Int. Cl. B60S 3/00; B08B 1/00

(52) U.S. Cl. 15/104.94; 15/118

(57) ABSTRACT

A car headlight cleaning device has a container and a threaded cap. The container has a body adapted to store liquid therein, and includes a threaded neck, and a grid located proximal to said threaded neck. The threaded cap includes threads adapted to removably connect with the threaded neck of the container, and a sponge member therein, such that when the threaded cap is screwed upon the container the sponge member is pressed against the grid and the liquid can be wrung out therefrom.

### FIELD OF THE INVENTION

The present invention relates generally to cleaning devices but more particularly to a bottle and sponge combination used for washing headlights.

### BACKGROUND OF THE INVENTION

There are many devices that have been developed for cleaning various parts of an automobile. There are also many types of cleaning systems using liquid and sponge systems. For example, U.S. Pat. No. 4,752,147 by Persi discloses a fluid applicator with a fluid containing jar, an applicator sponge attached to a lid, and a perforated plate for maintaining the sponge in a compressed state against the closed lid to regulate the amount of fluid which it can absorb. The sponge is compressed by inserting it into the jar so that it abuts the perforated plate while the lid simultaneously seals the jar. The extent of compression of the sponge, and thereby the amount of fluid which it can absorb, is regulated by adjusting the level of the perforated plate within the jar prior to exposing the fluid to the sponge. The disadvantage of this system is that it is difficult to determine beforehand the extent to which one has to adjust the level of the perforated plate to obtain proper compression of the sponge. Moreover, it is not possible to properly wring out the sponge unless the perforated plate is readjusted to apply more pressure to the sponge.

### SUMMARY OF THE INVENTION

In view of the foregoing disadvantages inherent in the known devices now present in the prior art, the present invention, which will be described subsequently in greater detail, is to provide objects and advantages which are to provide for a fast, easy, and practical way for cleaning headlights by having a device that can both wet and wring a sponge; that is easy to carry, and that is easy to use. By making it easy to clean headlights, the light output is enhanced, which provides for better safety on the roads. The invention makes use of reusable parts such as a sponge instead of wasting rags or paper, which makes it a more ecological product.

To attain these ends, the present invention generally comprises a container and a threaded cap. The threaded cap includes threads adapted to removably connect with the threaded neck of the container, and a sponge member therein, such that when the threaded cap is screwed upon the container the sponge member is pressed against the grid and the liquid can be wrung out therefrom.

The car headlight cleaning device further includes a cap resiliently deformable grill attached thereto and adapted to cover edge portions of the sponge member, thereby providing more scrubbing capability to the sponge member.

The sponge member extends outwardly from the threaded cap, such that a user can hold the cap in their hand and apply the sponge member to a headlight of a car.

The car headlight cleaning device has the sponge member removable from the threaded cap.

The body is formed with a narrow waist section adapted to offer a handle portion for more easily grasping the container and using the device by a user.

The cap further includes ridge members for more easily threading and removing the cap from the container.

In combination with a headlight the cleaning device becomes a combination having a light source with a transparent cover, and a cleaning device for cleaning the transparent cove. The cleaning device including a container and a threaded cap. The container having a body adapted to store liquid therein, and includes a threaded neck, and a grid located proximal to the threaded neck. The threaded cap includes threads adapted to removably connect with the threaded neck of the container, and a sponge member therein, such that when the threaded cap is screwed upon the container the sponge member is pressed against the grid and the liquid can be wrung out therefrom.

In a further combination of an automobile and a cleaning device. The automobile including at least one light source having a transparent cover; and a cleaning device for cleaning the transparent cover of the light source of the automobile. The cleaning device including a container and a threaded cap. The container having a body adapted to store liquid therein, and includes a threaded neck, and a grid located proximal to the threaded neck.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Isometric view of the invention.

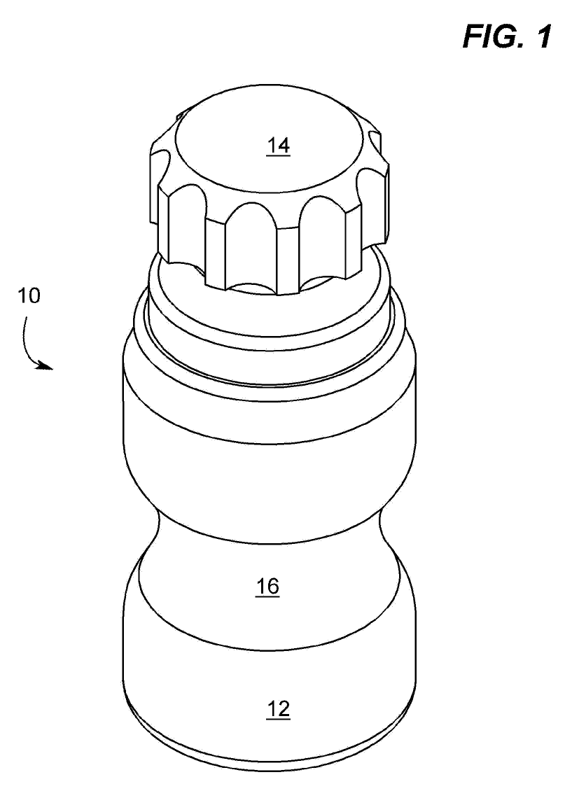

FIG. 2 Cutaway isometric view of the invention without the cap.

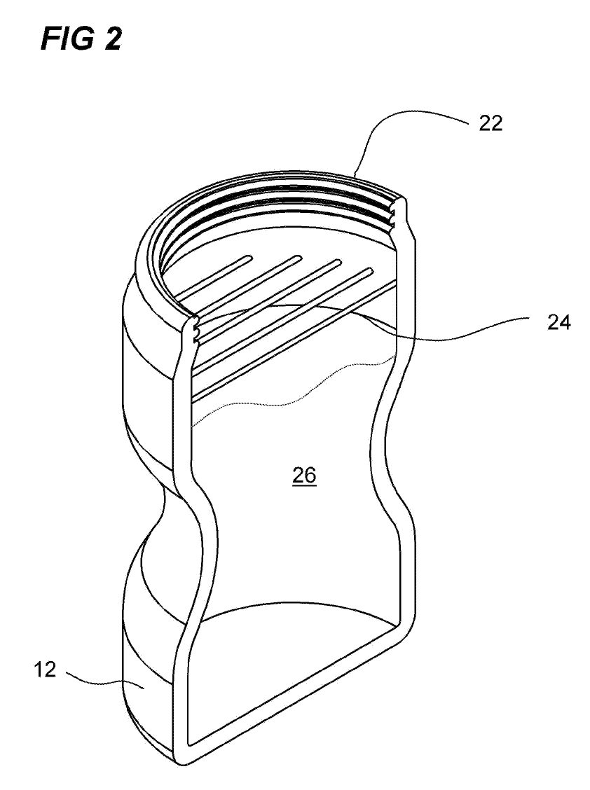

FIG. 3 Isometric view of the invention with the cap off.

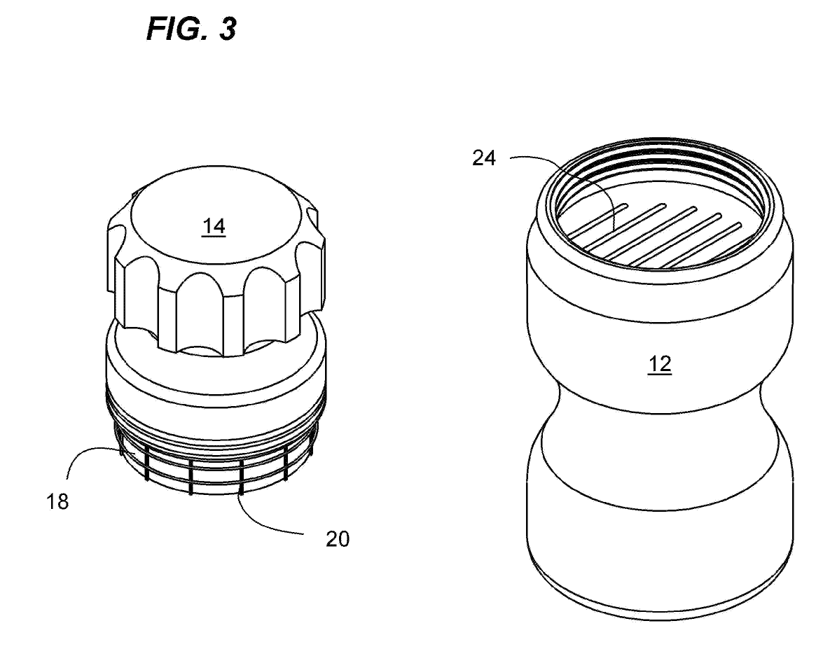

FIG. 4 Sid view of the invention

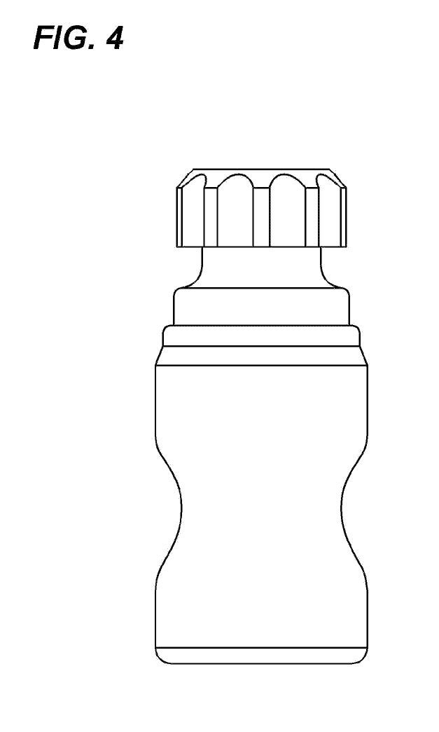

FIGS. 5a-b Cross section and side views, respectively, of the cap.

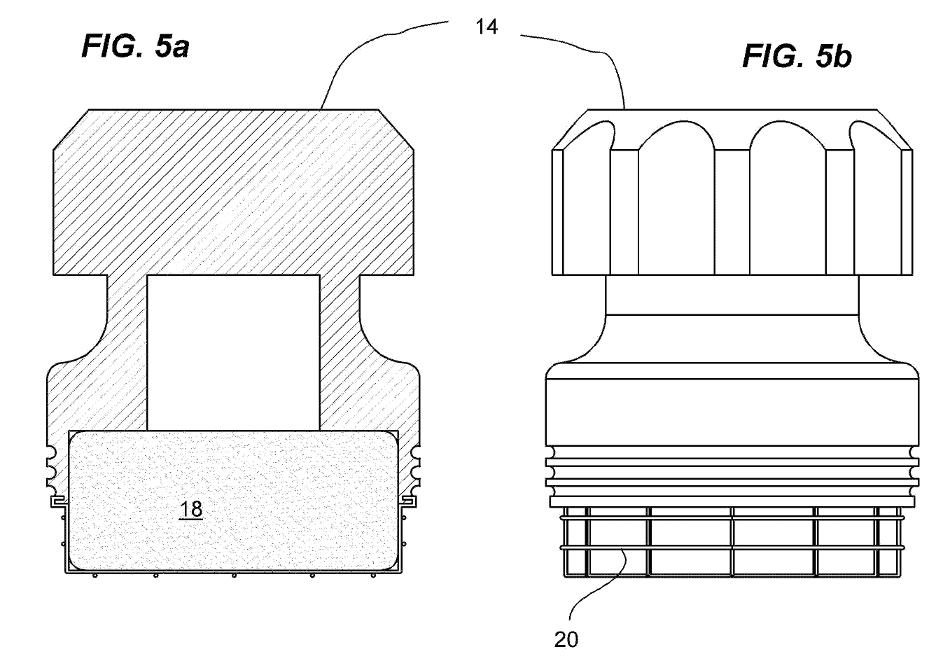

FIG. 6 Side view of the invention in context of use.

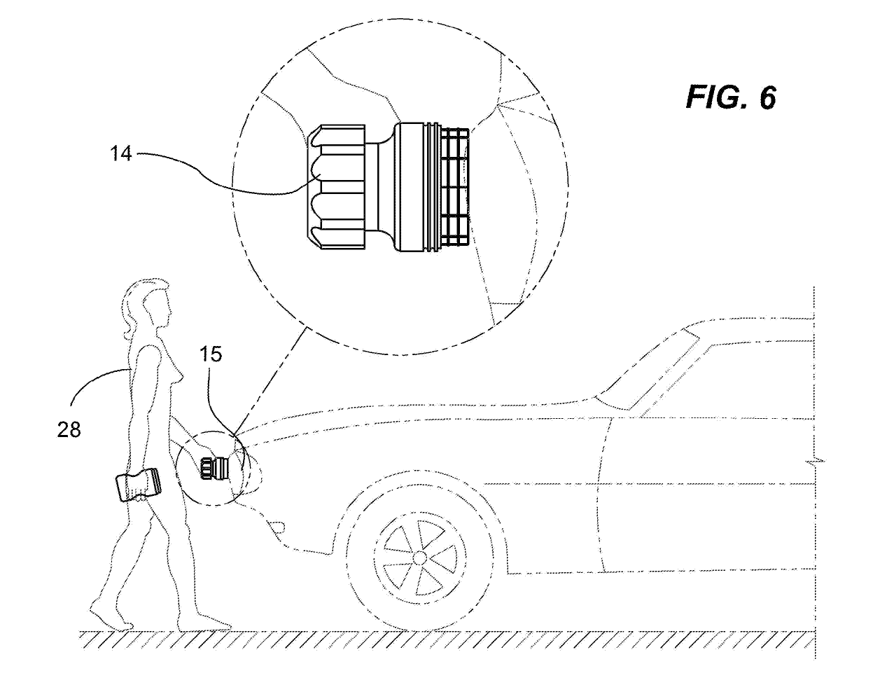

### DETAILED DESCRIPTION OF THE PREFERRED EMBODIMENT

A car headlight cleaning device (10) has a container body (12), and a threaded cap (14). The container body (12) is configured so as to contain a liquid (26). The body (12) is shaped ergonomically with a narrow waist (16) section for easy hand grasping and carrying by an intended user (28) while cleaning a headlight (15).

The cap (14) contains a sponge (18) which is preferably, but not necessarily, covered by a resiliently deformable grille (20) to provide more scrubbing capability to the sponge (18)—such as for removing bugs, for example—while providing enough flexibility to allow for the wringing of the sponge (18).

Proximal the threaded neck (22) is a grid (24) that is used for wringing the sponge (18) when the cap (14) is threaded in. The action of threading in the cap (14) moves it closer to the grid (24) which compresses the sponge (18), thus wringing it against the grid (24). Unscrewing the cap (14) when the container body (12) is upside down allows the sponge (18) to absorb more liquid as it expands away from the grid (24). That way, the sponge is full of liquid, ready for cleaning.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A car headlight cleaning device comprising:
a container and a threaded cap;
said container having a body adapted to store liquid therein, and includes a threaded neck, and a grid located proximal to said threaded neck;
said threaded cap includes threads adapted to removably connect with said threaded neck of said container, and a sponge member therein, such that when said threaded cap is screwed upon said container said sponge member is pressed against said grid and said liquid can be wrung out therefrom.

2. The car headlight cleaning device of claim 1, wherein cap further includes a resiliently deformable grill attached thereto and adapted to cover edge portions of said sponge member, thereby providing more scrubbing capability to said sponge member.

3. The car headlight cleaning device of claim 1, wherein said sponge member extends outwardly from said threaded cap, such that a user can hold said cap in their hand and apply said sponge member to a headlight of a car.

4. The car headlight cleaning device of claim 1, wherein said sponge member is removable from said threaded cap.

5. The car headlight cleaning device of claim 1, wherein said body is formed with a narrow waist section adapted to offer a handle portion for more easily grasping said container and using said device by a user.

6. The car headlight cleaning device of claim 1, wherein said cap further includes ridge members for more easily threading and removing said cap from said container.

7. A combination of a light source and a cleaning device, said combination comprising a light source having a transparent cover;
and a cleaning device for cleaning said transparent cover;
said cleaning device including a container and a threaded cap;
said container having a body adapted to store liquid therein, and includes a threaded neck, and a grid located proximal to said threaded neck;
said threaded cap includes threads adapted to removably connect with said threaded neck of said container, and a sponge member therein, such that when said threaded cap is screwed upon said container said sponge member is pressed against said grid and said liquid can be wrung out therefrom.

8. The combination of claim 7, wherein cap further includes a resiliently deformable grill attached thereto and adapted to cover edge portions of said sponge member, thereby providing more scrubbing capability to said sponge member.

9. The combination of claim 7, wherein said sponge member extends outwardly from said threaded cap, such that a user can hold said cap in their hand and apply said sponge member to a headlight of a car.

10. The combination of claim 7, wherein said sponge member is removable from said threaded cap.

11. The combination of claim 7, wherein said body is formed with a narrow waist section adapted to offer a handle portion for more easily grasping said container and using said device by a user.

12. The combination of claim 7, wherein said cap further includes ridge members for more easily threading and removing said cap from said container.

13. A combination of an automobile and a cleaning device; said automobile including at least one light source having a transparent cover; and a cleaning device for cleaning said transparent cover of said light source of said automobile; said cleaning device including a container and a threaded cap; said container having a body adapted to store liquid therein, and includes a threaded neck, and a grid located proximal to said threaded neck; said threaded cap includes threads adapted to removably connect with said threaded neck of said container, and a sponge member therein, such that when said threaded cap is screwed upon said container said sponge member is pressed against said grid and said liquid can be wrung out therefrom.

14. The combination of claim 13, wherein cap further includes a resiliently deformable grill attached thereto and adapted to cover edge portions of said sponge member, thereby providing more scrubbing capability to said sponge member.

15. The combination of claim 13, wherein said sponge member extends outwardly from said threaded cap, such that a user can hold said cap in their hand and apply said sponge member to a headlight of a car.

16. The combination of claim 13, wherein said sponge member is removable from said threaded cap.

17. The combination of claim 13, wherein said body is formed with a narrow waist section adapted to offer a handle portion for more easily grasping said container and using said device by a user.

18. The combination of claim 13, wherein said cap further includes ridge members for more easily threading and removing said cap from said container.

19.
